(19) United States
(12) Patent Application Publication
(10) Pub. No.: US 2024/0092006 A1
(43) Pub. Date: Mar. 21, 2024

(54) Method and Device for Producing a Coiled Tubing from a Thermoplastic Material

(71) Applicant: Truplast Kunststofftechnik GmbH, Langgöns (DE)

(72) Inventors: Marco Holst, Bensheim (DE); Ingo Steitz, Staufenberg (DE)

(21) Appl. No.: 18/038,172

(22) PCT Filed: Nov. 22, 2021
(86) PCT No.: PCT/EP2021/082561

§ 371 Date: May 22, 2023

(30) Foreign Application Priority Data
Nov. 23, 2020 (DE) 10 2020 007 133.3

(51) Int. Cl. B29C 48/00; B29C 48/09; B29C 48/88; B29C 48/90; B29C 53/32

(52) U.S. Cl. CPC B29C 48/0019; B29C 48/0022; B29C 48/09; B29C 48/901; B29C 48/9115; B29C 53/32; B29C 2793/009; B29K 2077/00

(57) ABSTRACT

In a method for producing a coiled tubing (RW) from a thermoplastic material, in a first shaping step a tubular extrudate (EX) is extruded via an annular nozzle gap (16) in an extruder (12) before, in a second shaping step directly following the first shaping step, the extrudate which is drawn down from the nozzle gap and is still plastically deformable is calibrated in a shaping device (18) in order to obtain a geometrically defined profile cross section (PQ) and is shaped into the coiled tubing, whereupon the coiled tubing having the geometrically determined profile cross section solidifies. This method allows for continuous production of the coiled tubing with a new, high quality in respect of dimensional and shape tolerances on the profile cross section of the coiled tubing. The invention also relates to a device (10) for producing such a coiled tubing.

### TECHNICAL FIELD

The present invention relates to a method and a device for producing a coiled tubing from a thermoplastic plastics material. In particular, the invention relates to a method and a device for producing a coiled tubing as connecting lines of, for example, compressed air brake systems such as are used on a large scale in, for example, semitrailers or trailer tractors.

### BACKGROUND OF THE INVENTION AND STATE OF THE ART

Pressure-resistant resiliently bendable coiled tubing of polyamide (PA) is standardized as connecting lines of compressed air brake systems in semitrailers and trailer tractors (DIN 74 323 with reference to, inter alia, DIN 74324-1 with respect to tube material). The subject of the first-mentioned Standard is, apart from sizes, designations and markings on the finished coiled tubing provided with a kink protection and connectors, the materials used for tube and connecting parts, the surface property thereof, the allowable excess operating pressure and operating temperature range, the requirements with respect to stretch force, restoration behavior, pull-off force of the screw connections, security against kinking, tightness and the tests to be carried out for checking fulfilment of the requirements standardized in that respect. As far as size is concerned, the outer diameter of the tube is provided in the Standard with a plus/minus tolerance taking into consideration ovality of the tube cross-section resulting from coiling of the tube, i.e. due to the conventional method of producing coiled tubing from a thermoplastic plastics material.

In the prior art, in order to produce coiled tubing from a thermoplastically processible polymer usually an extruded tube with a predetermined cross-section is cut to length, helically wound in a cold state, preferably at room temperature, about a mandrel, wherein the tube is oriented with its longitudinal axis approximately at right angles to the mandrel axis or helix axis, and subsequently subjected to thermofixing. Methods of that kind for production of coiled tubing by subsequent shaping through winding and thermofixing are known from, for example, the documents U.S. Pat. Nos. 3,021,871 and 3,245,431.

In order to improve this prior art with respect to the restoration capability of the produced coiled tubing a method of manufacturing coiled tubing is in addition proposed in the document DE 39 43 189 A1 in which the tube cut to length is, during feed thereof for winding on the mandrel, rotated about its longitudinal axis in a rotational direction counter to the rotational direction of the forming helix as seen in feed direction. Moreover, document DE 39 43 189 A1 teaches performance of thermofixing of the extruded tube, which is rotated about its longitudinal axis and wound up, preferably in air or in a liquid medium, which can be a mineral-oil bath, silicon-oil bath or polydiol bath. In that case, the fixing duration depends on the wall thickness of the tube and can be, for example, 10 to 15 minutes for 1 millimeter polyamide and 20 to 30 minutes for 2 millimeter polyamide in air. This thermofixing of the coiled tubing is usually carried out in a closed oven at a temperature of 120° C. to 160° C.

This multi-stage production process is time-consuming, occasions a not inconsiderable logistical outlay and also is not energy-efficient. In particular, initially the thermoplastic plastics material for extrusion of the straight tube has to be melted and subsequently thereto cooled back down to room temperature. After cutting to length and winding up, the coiled tube has to be heated again as described above so as to thermally fix the coiled tubing.

Moreover, it is common to the known production methods described to that extent that as a consequence of the winding process an ovality of the tube cross-section of the finished coiled tubing arises (cf. with respect thereto the accompanying FIG. 15), as is discussed in the above-mentioned Standard and may not be desired for specific uses. Furthermore, endless production of coiled tubing is not possible by such a procedure.

Finally, an alternative method for producing coiled tubing is disclosed in the document GB 1 518 424. In the case of this prior art in a first process step a tube is extruded, loosely wound up and cooled. In a second process step the tube is reheated and formed into a helix with the aid of guide roller pairs, wherein in each instance one guide roller is arranged within and one guide roller outside the helix. In that regard, all guide rollers are driven by a suitable transmission. The thus-produced, still-hot helix is thereafter cooled, during which it is supported by support rollers which are similarly driven by the transmission.

Apart from increased high expenditure of time and energy a disadvantage of this prior art is to be seen particularly in the fact that there is a risk of the tube cross-section of the initially cooled-down extruded tube undesirably distorting after reheating thereof during winding into the helix.

### Object

Starting from the prior art according to document GB 1 518 424 the invention has the object of providing a simplest possible method for producing coiled tubing from a thermoplastic plastics material, which addresses the problems discussed above with respect to the prior art. In particular, the production method shall make possible (endless) manufacture of coiled tubing with a geometrically clearly defined profile cross-section of the tube, for example a circularly annular profile cross-section, as rapidly and economically as possible. The object of the invention further comprises the provision of a device for production of such coiled tubing, which allows production of the coiled tubing in endless manufacture as simply, rapidly and economically as possible.

### Illustration of the Invention

These objects are fulfilled by a method of producing coiled tubing from a thermoplastic plastics material with the features of claim 1 and a device for producing coiled tubing from a thermoplastic plastics material with the features of claim 9. Advantageous embodiments of the invention are the subject of the dependent claims.

A method according to the invention for producing coiled tubing from a thermoplastic plastics material is distinguished by the fact that after a tubular extrudate has been extruded via an annular nozzle gap of an extruder in a first shaping step the extrudate, which is drawn down from the nozzle gap and capable of being shaped plastically, is in a second shaping step directly subsequent to the first shaping step calibrated or sized in a shaping device to achieve a geometrically defined profile cross-section and formed into coiled tubing before the coiled tubing with the geometrically defined profile cross-section solidifies.

With respect to the device the invention provides a device for producing coiled tubing from a thermoplastic plastics material, comprising an extruder with an injection head having an annular nozzle gap by way of which a tubular extrudate in a state capable of being shaped plastically can be delivered, and a shaping device for further shaping of the tubular extrudate, which is capable of being shaped plastically, to form the coiled tubing with a geometrically defined and calibrated or sized profile cross-section, wherein the shaping device is driven and so arranged with respect to the injection head of the extruder that it is capable of drawing the tubular extrudate in the state capable of being shaped plastically directly down from the annular nozzle gap.

With respect to the method and device the invention is thus directed in its core to continuous further shaping of the extrudate, which is drawn down from the nozzle gap and capable of being shaped plastically, directly after the extruding, thus without intermediate cooling/solidifying or cutting to length, and in particular in such a way that the helical shape is created and the profile cross-section of the resulting coiled tubing calibrated or sized in geometrically defined manner at the same time.

This procedure advantageously makes it possible to produce coiled tubing in endless manufacture and very rapidly. In that case, fewer manufacturing steps than in the case of the previously known production methods are needed. Moreover, by comparison with the afore-described prior art less energy is needed for that purpose. In sum, production of the coiled tubing is faster and more efficient with respect to time and costs than in the prior art.

In addition, according to the invention a geometrically defined and calibrated or sized profile cross-section of the coiled tubing arises only in the shaping device, by contrast to the prior art which is outlined in the introduction and in which as a consequence of shaping to form the coiled tubing the profile cross-section of the tube is not completely retained, but experiences distortion (ovality). The profile cross-section of the coiled tubing produced in accordance with the invention thus has a new, better quality with respect to tolerances of shape and size.

Thus, for example, the extrudate capable of being shaped plastically can be calibrated or sized in the second shaping step so as to achieve a substantially circularly annular profile cross-section. However, production of other annular cross-sectional shapes, for example waved or polygonal annular cross-sections of the coiled tubing, is equally possible with a high level of shape integrity as desired or required.

In an advantageous embodiment of the production method the extrudate capable of being shaped plastically can, for the second shaping step, be drawn down from the nozzle gap by the shaping device. However, the arrangement can also be such that drawing down takes place by gravitational force from a vertically oriented extruder.

With respect to a particularly high degree of shape integrity of the profile cross-section of the produced coiled tubing it has further proved advantageous if in a preferred embodiment of the production method the calibrating or sizing of the extrudate capable of being shaped plastically is carried out in the shaping device with the feed of supporting air through a cavity of the extrudate.

For that purpose, the injection head of the extruder can have a supporting air bore which opens at an end surface of the injection head radially within the annular nozzle gap. Alternatively, it is possible to form the nozzle gap to be somewhat longer and to deliver the supporting air from radially within directly into the nozzle gap, which can also facilitate drawing-down of the extrudate from the nozzle gap.

In principle, it is possible for the extrudate during the second shaping step in the shaping device to cool down passively and solidify. By contrast, however, it is preferred particularly with a view to rapid conduct of the process if the extrudate is actively cooled during the second shaping step in the shaping device.

Use can be of, for example cold air, which is blown onto the extrudate in the shaping device, for active cooling of the extrudate. With respect to particularly good removal of heat from the extrudate and the shaping device it is preferred to use a liquid coolant such as, for example, water for active cooling of the extrudate in the shaping device.

With regard to the device, a cooling device for delivery of a cooling fluid can be provided for that purpose in the region of the shaping device, the extrudate conveyed through the shaping device being actively coolable with the aid of the cooling device.

The making-up of the coiled tubing with respect to length and exits or connections is carried out only after the solidified coiled tubing has left the shaping device. Thus, the solidified coiled tubing after leaving the shaping device can be cut to length in defined manner in a first making-up step. In a second making-up step the coil tubing cut to defined length can then be provided at one or both ends with a kink protection and/or a connecting member.

The afore-described making-up steps can, but do not have to, be carried out at the manufacturer of the coiled tubing. It is also possible for the coiled tubing manufactured in endless form to be delivered in a very long piece (or cut to length only in defined manner) for (further) making up, for example at the manufacturer of terminal equipment, such as compressors, or of compressed-air brake systems where mounting of the connecting members with or without a kink protection is then carried out.

One possibility for shaping the coiled tubing (helical course and cross-sectional calibration) in the shaping device consists of, for example, providing the latter with two endless belts which are slack in terms of bending and between which further shaping of the extrudate drawn down from the extruder is carried out. In that case, the two endless belts are configured as shaping belts with a flute-like recess extending along the respective belt. One of the endless belts is wound, as an inner shaping belt with a suitable lateral guide, helically around a rotatable, approximately cylindrical core, for example with three to five windings, and, in particular, so that the flute-like recess faces radially outwardly. By way of example, two axially spaced-apart deflecting rollers for the inner shaping belt are provided at a radial spacing from the rotatable core. The inner shaping belt is guided towards the rotatable core by way of one deflecting roller, while the other deflecting roller serves the purpose of guiding the inner shaping belt away from the core so that the inner shaping belt encircles the core and the deflecting rollers in an endless loop. By contrast, the other endless belt is wound as an outer shaping belt following the helical course of the inner shaping belt and with appropriate mechanically positive guidance around the inner shaping belt and, in particular, in such a way that the flute-like recess faces radially inwardly towards the core. A further deflecting roller pair for the outer shaping belt is arranged on the side, which is opposite with respect to the core, towards the deflecting rollers for the inner shaping belt and in analogous manner serves the purpose guiding the outer shaping belt in an endless loop towards the rotatable core and away from the core. The inner and outer shaping belts thus form, by their mutually facing flute-like recesses, a hollow helical track for shaping the tubular extrudate, which is drawn down from the extruder, to form the coiled tubing with a geometrically defined and calibrated or sized profile cross-section.

However, by contrast with a shaping device designed in such a way an embodiment is preferred, particularly with respect to a high level of process reliability, in which the shaping device comprises a plurality of rotationally drivable shaping shafts which are arranged in such a manner on a mount, which is secure against rotation, that they form an inner ring of shaping shafts and an outer ring of shaping shafts, wherein the shaping shafts of the inner ring are drivable in opposite direction to the shaping shafts of the outer ring so as to convey the tubular extrudate, which is capable of being shaped plastically, between the inner ring and the outer ring. In that regard, each shaping shaft can have a plurality of shape-imparting radial grooves with a geometrically defined groove cross-section, the grooves being arranged in succession at a slight spacing from one another as seen along a center axis of the shaping shaft. In order to achieve, for example, a substantially circularly annular profile cross-section the shape-imparting radial grooves of the shaping shafts have a substantially semicircular groove cross-section; other groove cross-sectional shapes are, however, also possible in correspondence with the desired or required form of the profile cross-section of the coiled tubing to be produced.

The shaping shafts preferably project to different extents from the shaft mount in correspondence with the pitch of the coiled tubing to be produced and/or with the center axes thereof tilted with respect to a center axis of the shaft mount so as to form by their shape-imparting radial grooves a substantially helical track for the tubular extrudate which is capable of being shaped plastically. As an alternative thereto, the radial grooves can be formed in the respective shaping shaft at a different axial position and/or a tilting of the respective shaping shaft in terms of angle can be dispensed with so that this extends parallel to the center axis of the shaft mount. On the other hand, however, the afore-mentioned embodiment is preferred because on the one hand the shaping shafts of the respective ring can be economically constructed as identical parts and on the other hand the created substantially helical track for the extrudate extends more uniformly, which is also conducive to easier guidance of the extrudate between the shaping shafts.

Moreover, an embodiment of the shaping device in which at least one shaping shaft of the outer ring is of multi-part construction—more preferably all shaping shafts of the outer ring are of multi-part construction—with a (respective) shaft stub, which is rotatably mounted in the shaft mount, and a shaft segment, which can be detachably mounted on the stub and which has the shape-imparting radial grooves of the shaping shaft, is preferred particularly with respect to a simplest possible startup of production of the coiled tubing and a high level of operating reliability in the production of the coiled tubing.

In that regard, in a particularly economic and simple embodiment the or each shaping shaft, which is of multi-part construction, of the outer ring can have a magnetic coupling serving the purpose of detachably retaining the shaft segment at the shaft stub. Particular advantages of this form of connection are that the mounting of the shaft segment on the associated shaft stub takes place very simply and a shaft segment once deflected out of its connection with the associated shaft stub can automatically move back into its starting position at the shaft stub. However, other connecting solutions with a mechanically positive and/or friction couple such as, for example, a ball catch or a clamp are also conceivable here.

The shaft segment and the shaft stub of the shaping shaft, which is of multi-part construction, of the outer ring can, in addition, can be provided with structures which are of complementary configuration and which can be brought into interlocking engagement with one another for transmission of torque, which is more reliable by comparison with other possibilities of torque transmission by, for example, a force-locking or friction couple. In an expedient embodiment, which is preferred with respect to a good capability of tilting of the shaft segment relative to the associated shaft stub, the complementary structures of shaft segment and shaft stub can be formed by pins at one part and outwardly open recesses at the other part, which pins and recesses interengage in the mounted state of the shaping shaft, which is of multi-part construction, of the outer ring.

In a simple embodiment of the device the shaping shafts of the outer ring and the shaping shafts of the inner ring are drivable by a common drive device. Alternatively thereto, two or more drive devices can also be provided to drive the shaping shafts flexibly in annular manner or even individually in correspondence with the respective shaping requirements and in a given case different cross-sectional dimensions of the coiled tubing to be produced.

In that case, in a particularly simple construction the common drive device can have a motor which is in driving connection with an input shaft of a radial transfer transmission having output shafts corresponding with the number of shaping shafts of the shaping device, the output shafts in turn each being in driving connection with a respective shaping shaft of the shaping device.

The output shafts of the radial transfer transmission are preferably in driving connection with the shaping shafts of the shaping device by way of telescopic universal-joint shafts. Advantages here are that a simple adaptability to different shaft mounts is given and thus a rapid tool change in the shaping device is possible; in addition, telescopic universal-joint shafts of that kind are readily available on the market as bought-in parts.

In a particularly advantageous embodiment of the device the radial transfer transmission of the drive device can comprise two transmission stages, namely a transmission stage for drive of the shaping shafts of the inner ring and a transmission stage for drive of the shaping shafts of the outer ring, wherein the translation ratios of the transmission stages are selected in such a way that different circumferential speeds arise at the shaping shafts of the inner ring and the shaping shafts of the outer ring so as to convey the extrudate through the shaping device substantially free of distortion. Alternatively, it is certainly also possible to not provide compensation for the necessarily different circumferential speeds at the inner circumference and outer circumference of the produced coiled tubing due to the different diameters, thus not use transmission stages with different translation ratios here. However, this leads to a certain degree of slip between the shaping shafts and the extrudate, which can require slowing down of production of the coiled tubing so as to not damage the extrudate, for which reason this alternative is less preferred.

In further pursuit of the concept of the invention the device can further comprise a coiled tubing take-off which is downstream of the shaping device in the material flow and which comprises two take-off rollers extending substantially parallel to one another, the rollers being adapted for the purpose of rotationally supporting the coiled tubing after leaving the shaping device. This is of advantage in, for example, endless production of very lengthy coiled tubing, because the shaping device is significantly relieved of load by the coiled tubing take-off particularly even in the case of comparatively rapid speeds of advance of the coiled tubing.

Finally, the coiled tubing take-off can preferably comprise a rotary drive by which the take-off rollers are rotationally drivable in the same direction oppositely to the rotational direction of the coiled tubing delivered by the shaping device. Through suitable selection of the rotational speed for the drive of the take-off rollers it is thus advantageously possible to further assist and smooth the process of drawing the coiled tubing out of the shaping device.

Further features, characteristics and advantages of the method according to the invention and device according to the invention for producing coiled tubing from a thermoplastic plastics material will be evident to the person skilled in the art from the following description of a preferred embodiment.

### BRIEF DESCRIPTION OF THE DRAWINGS

The invention is explained in more detail in the following by way of a preferred embodiment with reference to the accompanying, partly schematic drawings, in which the same or corresponding parts or sections are provided with the same reference numerals and in which:

FIG. 1 shows a perspective view of a device according to the invention for producing coiled tubing from a thermoplastic plastics material, from obliquely above and front right, with a view of a tubular extrudate which is delivered in a state capable of being shaped plastically, from an injection head of an extruder and is directly drawn down by a shaping device for further shaping of the extrudate to form the coiled tubing with a geometrically defined and calibrated or sized profile cross-section;

FIG. 2 shows a plan view, which is to reduced scale, of the device according to FIG. 1 for further illustration of the physical relative positions of the extruder and the shaping device of the device;

FIG. 3 shows a front view of the device according to FIG. 1 from below in FIG. 2 and to the scale of FIG. 2;

FIG. 4 shows a front view, which is to enlarged scale, of the injection head, which is separated from the extruder, of the device according to FIG. 1;

FIG. 5 shows a sectional view, which is broken away downwardly and upwardly and is to enlarged scale by comparison with FIG. 4, of the injection head of the device according to FIG. 1 in correspondence with the section line V-V in FIG. 4;

FIG. 6 shows a sectional view, which is broken away at the circumference, of the injection head of the device according to FIG. 1 in correspondence with the section line VI-VI in FIG. 5 and to the scale of FIG. 5;

FIG. 7 shows a front view, which is to enlarged scale by comparison with FIG. 3, of a subassembly of the shaping device of the device according to FIG. 1 in a state separated therefrom, comprising, in particular, a radial transfer transmission which is drivingly connected by way of an arrangement of telescopic universal-joint shafts with shaping shafts of the shaping device, the shaping shafts in turn being rotatably mounted on a shaft mount secure against rotation;

FIG. 8 shows a sectional view, which is broken away at both sides and is to enlarged scale by comparison with FIG. 7, of the subassembly shown therein of the shaping device of the device according to FIG. 1 in correspondence with the section line VIII-VIII—which is angled once—in FIG. 7;

FIG. 9 shows a sectional view of the radial transfer transmission of the device according to FIG. 1 in correspondence with the section line IX-IX in FIG. 8 for illustration of the two transmission stages of the radial transfer transmission, wherein the torque plot is indicated by dashed lines and the rotational directions of the individual gearwheels are indicated by arrows;

FIG. 10 shows a sectional view of the radial transfer transmission of the device according to FIG. 1 in correspondence with the section line X-X in FIG. 8 for further illustration of the two transmission stages of the radial transfer transmission, wherein again the torque plot is indicated by dashed lines and the rotational directions of the individual gearwheels are indicated by arrows;

FIG. 11 shows a perspective view from obliquely above and left right of the shaft mount with the shaping shafts of the subassembly, which is shown in FIG. 7, of the shaping device of the device according to FIG. 1 in a state separated therefrom, wherein in an upper region of FIG. 11 the tubular extrudate, which is in the state capable of being shaped plastically, is indicated broken away on both sides and as it enters the shaping device, and arrows indicate the rotational directions of the individual shaping shafts;

FIG. 12 shows a plan view of the shaft mount, which is shown in isolation in FIG. 11, with the shaping shafts of the shaping device of the device according to FIG. 1, in particular for illustration of tilting of the shaping shafts with respect to a center axis of the shaft mount and the rotational directions thereof again indicated by arrows, wherein in an upper region of FIG. 12 the tubular extrudate, which is in the state capable of being shaped plastically, is again indicated entering the shaping device and broken away on both sides;

FIG. 13 shows a side view—which is interrupted once—of coiled tubing, which is produced in accordance with a method according to the invention, of a thermoplastic plastics material, which has a circularly annular profile cross-section;

FIG. 14 shows a sectional view, which is to an enlarged scale and is broken away on both sides, of the coiled tubing according to FIG. 13 in correspondence with the section line XIV-XIV in FIG. 13 for illustration of the circularly annular, calibrated or sized profile cross-section of the coiled tubing; and

FIG. 15 shows a sectional view, which corresponds in sectional course with FIG. 14, of coiled tubing produced in conventional manner from a thermoplastic plastics material, for illustration of the then-resulting substantially oval profile cross-section of the coiled tubing.

### DETAILED DESCRIPTION OF THE EMBODIMENT

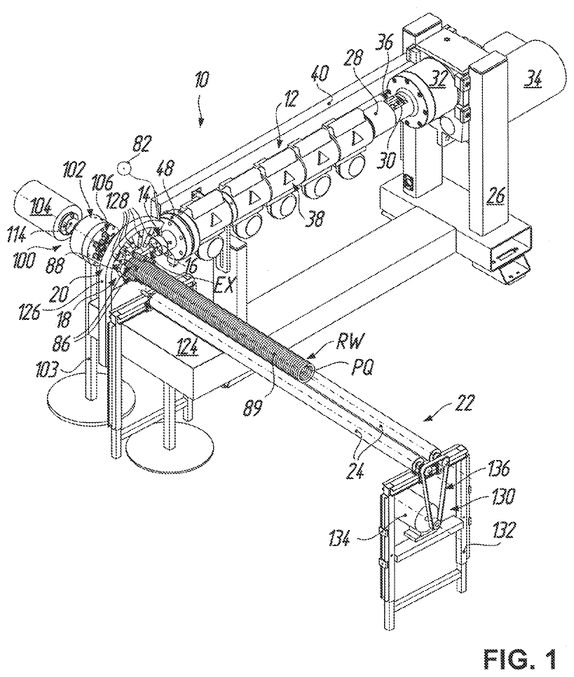

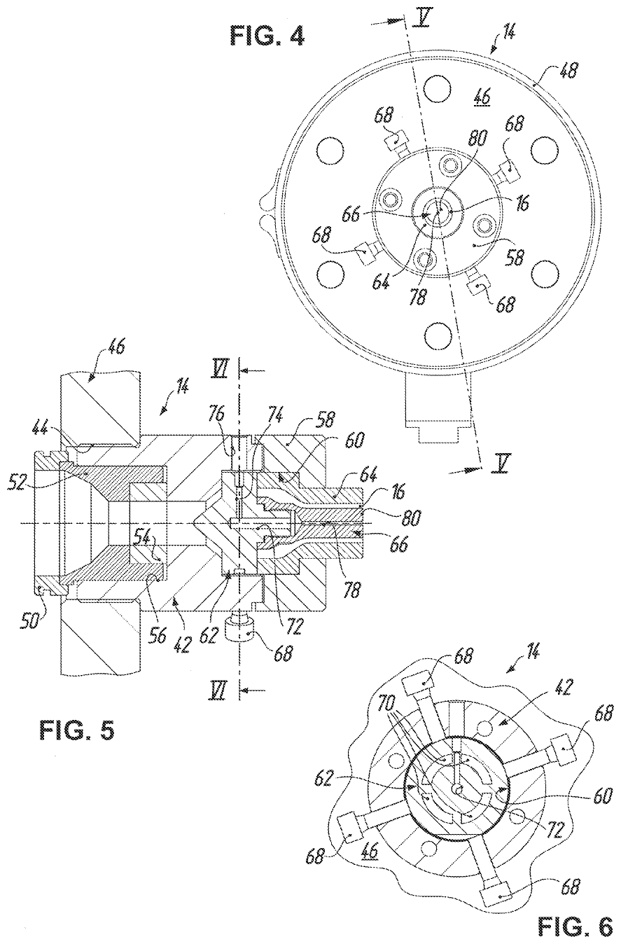

A device for producing coiled tubing RW from a thermoplastic plastics material is denoted in FIGS. 1 to 3 by the reference numeral 10. The device 10 comprises in general an extruder 12 with an injection head 14, which is described in more detail in the following and which according to FIGS. 4 and 5 has an annular nozzle gap 16 by way of which a tubular extrudate EX in a state capable of being shaped plastically can be delivered. Further, the device 10 comprises a shaping or reshaping device 18, which is similarly discussed in more detail in the following, for further shaping of the tubular extrudate EX, which is capable of being shaped plastically, to form the coiled tubing RW with a geometrically defined, calibrated profile cross-section PQ (cf. FIG. 14). Important features of the device 10 in that case consist of the fact that the driven shaping device 18 is so arranged with respect to the injection head 14 of the extruder 12 that it can draw down the tubular extrudate EX, which is in the state capable of being shaped plastically, directly from the annular nozzle gap 16 of the injection head 14, i.e. directly before calibrating of the profile cross-section PQ of the tube and shaping thereof to form the coiled tubing RW are carried out.

As far as the further subassemblies of the device 10 in general form are concerned, a cooling device 20 for the coiled tubing RW and a coiled tubing take-off 22 are in addition illustrated in FIGS. 1 to 3. The cooling device 20 of the device 10 is provided in the region of the shaping device 18 and serves for delivery of a cooling fluid, here water, so as to actively cool the extrudate EX conveyed through the shaping device 18. The coiled tubing take-off 22 of the device 10, thereagainst, is provided downstream of the shaping device 18 in the material flow and comprises two take-off rollers 24 which extend substantially parallel to one another and are adapted for the purpose of rotationally supporting the coiled tubing RW after leaving the shaping device 18.

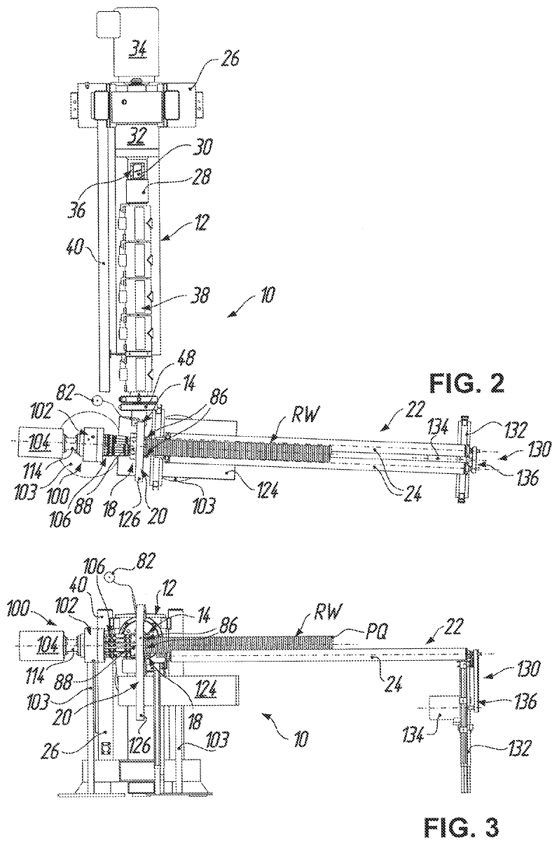

In the illustrated embodiment the extruder 12 is a worm extruder, which is mounted on or in a base frame 26 and which is known per se, with a worm cylinder 28 for reception of an extruder worm 30 (see FIGS. 1 and 2), which is rotatably mounted by way of (inter alia) a thrust bearing (not visible in the figures) received in a thrust bearing bell 32 and which can be rotationally driven by a geared motor 34. Near the thrust bearing bell 32 the worm cylinder 28 is provided with a filling opening 36 with which, for example, a filling funnel (not shown) for the feed of the plastics material to be processed can be connected.

The thermoplastic plastics material, in the present case, for example, a polyamide (PA), such as PA 12 or PA 6, or alternatively a polyethylene (PE) or polyurethane elastomer (PUR), is melted in the worm cylinder 28 or at the extruder worm 30 of the extruder 12 at temperatures lying around 20° above the melting point of the respective material. For that purpose, use is made of a heating/cooling combination 38, the heating bands of which are arranged at the outer circumference of the worm cylinder 28. The reference numeral 40 denotes in FIGS. 1 to 3 a cable channel for energy feed to the heating/cooling combination 38.

In the worm cylinder 28 the extruder 12 has along the extruder worm 30 functional zones which differ in a manner known per se, namely an intake zone which is connected with the filling opening 36 and which transitions into a middle compression zone, which is in turn connected with an ejection zone ending with the injection head 14, by way of the nozzle gap 16 of which the extrudate EX can be drawn down from the extruder 12. Reference is made in the following to FIGS. 4 to 6 with respect to further details of the injection head 14.

The injection head 14 has a base body 42 which is screwed into a central threaded bore 44 of an annular flange member 46, by way of which the injection head 14 is flange-mounted on the worm cylinder 28. A heating band 48 of the heating/cooling combination 38 can be seen in FIG. 4 at the outer circumference of the flange member 46. In that case, the injection head 14 is connected with an outlet opening (not shown) of the worm cylinder 28 by way of a centering ring 50, with which an injection head inlet 52 tapering towards the inner circumference is connected, the inlet being mounted in a stepped bore 56 of the base body 42 by a spacer ring 54.

A nozzle holder 58 is secured to the base body 42 at the end of the base body 42 remote from the flange part 46 and together with the base body 42 bounds an interior space 60 for receiving a webbed mandrel holder 62 and an outer nozzle 64 of the injection head 14. An inner nozzle 66 of the injection head 14 is screwed onto the webbed mandrel holder 62 and together with the outer nozzle 64 forms the annular nozzle gap 16 of the injection head 14. An outer diameter of the webbed mandrel holder 62 is slightly smaller than an inner diameter of the interior space 60 in the region of the base body 42 so that the webbed mandrel holder 62 can radially move in the inner space 60 and thus be centered. For this purpose, in the illustrated embodiment four centering screws 68 uniformly distributed over the circumference are provided and are screwed into and pass through associated threaded bores of the base body 42 so as to come into contact with the outer circumference of the webbed mandrel holder 62. It will be apparent to the skilled person that the webbed mandrel holder 62 can be fixed by the centering screws 68 in the interior space 60 in a radial setting in which the outer nozzle 64 and the inner nozzle 66 are aligned so as to set an exact circularly annular form of the nozzle gap 16 of the injection head 14.

According to FIG. 6 the webbed mandrel holder 62 further comprises four passages 70 separated from one another by webs and having the form of a segment of a circular ring. The extrudate EX capable of being shaped plastically and fed by the worm cylinder 28 through the injection head inlet 52, the spacer ring 54 and the stepped bore 56 in the base body 42 can be further conducted by way of the passages 70 to the annular space between the inner nozzle 66 and the outer nozzle 64 and thus the nozzle gap 16 of the injection head 14.

Moreover, the webbed mandrel holder 62 has a central blind bore 72 which, according to FIG. 5, is in fluid connection via a transverse bore 74 in the webbed mandrel holder 62 with a connecting bore 76 formed transversely in the base body 42. In addition, the blind bore 72 of the webbed mandrel holder 62 is in fluid connection with a central supporting air bore 78 of the injection head 14, more precisely the inner nozzle 66 of the injection head 14. This supporting air bore 78 in turn opens at an end surface 80 of the injection head 14 radially within the annular nozzle gap 16, as can be best seen in FIG. 5. It is thus possible to connect a compressed air source 82 (schematically indicated in FIGS. 1 to 3), which optionally is pressure-regulated, with the injection head 14 so as to load the extrudate EX, which is drawn down from the nozzle gap 16 and capable of being shaped plastically, with a specific internal pressure, for example 50 mbar, by way of the supporting air bore 78 of the injection head 14.

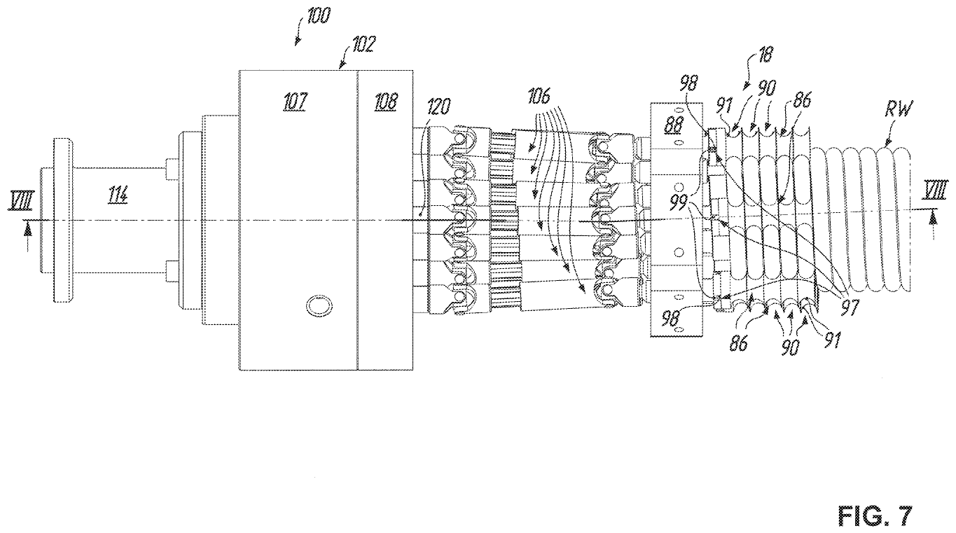

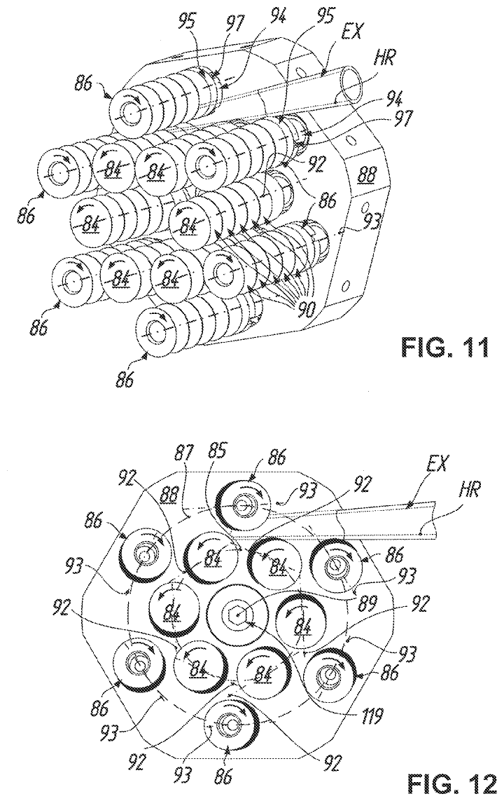

Further details of the shaping device 18 can be inferred from, in particular, FIGS. 7 to 12. As can be best seen in FIGS. 11 and 12, the shaping device 18 first and foremost comprises a plurality of rotationally drivable shaping shafts 84, 86, which are so arranged at a shaft mount 88 secure against rotation that they form an inner ring 85 of—in the illustrated embodiment, six—inner shaping shafts 84 and an outer ring 87 of—in the illustrated embodiment, similarly six—outer shaping shafts 86, the rings being indicated in FIG. 12 by dashed lines. In that regard, the shaping shafts 84 of the inner ring 85 are drivable in correspondence with the rotational arrows in FIGS. 11 and 12 in opposite direction to the shaping shafts 86 of the outer ring 87 so as to convey the tubular extrudate EX, which is capable of being shaped plastically, between the inner ring 85 and the outer ring 87. In other words, in the viewing angle of FIGS. 11 and 12 the driven shaping shafts 84 of the inner ring 85 each rotate in anticlockwise sense whilst the driven shaping shafts 86 of the outer ring 87 each rotate in clockwise sense.

It can also be readily seen in FIG. 12 that the shaping shafts 84 of the inner ring 85 and the shaping shafts 86 of the outer ring 87 are uniformly angularly spaced from one another on their respective ring about a center axis 89 of the shaft mount 88, in particular in each instance by 60°. In that case, the shaping shafts 84 of the inner ring 85 are arranged to be angularly offset relative to the shaping shafts 86 of the outer ring 87 about the center axis 89 of the shaft mount 88 by 30° so that each shaping shaft 84 of the inner ring 85 is seated “in the gap” with respect to the adjacent two shaping shafts 86 of the outer ring 87.

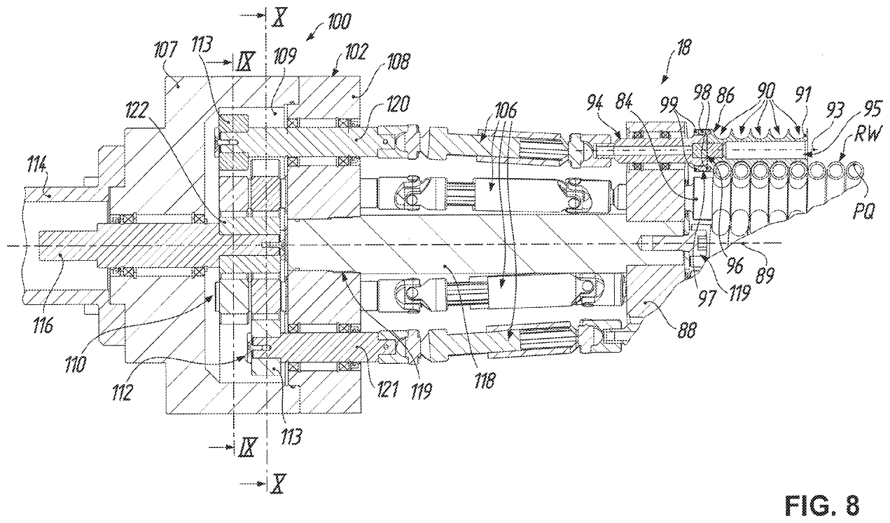

Each shaping shaft 84, 86 further comprises a plurality of—in the illustrated embodiment, five—shape-imparting radial grooves 90 with a geometrically defined groove cross-section 91, which as seen along a center axis 92, 93 of the respective shaping shaft 84, 86 are arranged in succession at a small spacing from one another, as can be best seen in FIGS. 8 and 11. In the illustrated embodiment the shape-imparting radial grooves 90 of the shaping shafts 84, 86 each have a substantially semicircular groove cross-section 91.

As, moreover, can be best seen in FIGS. 7, 11 and 12, the shaping shafts 84, 86 are amongst themselves differently arranged or oriented in relation to the shaft mount 88 with respect to axial spacing and tilt angle. On the one hand, the shaping shafts 84, 86 project a different distance from the shaft mount 88 in correspondence with the pitch of the coiled tubing RW to be produced (cf. FIG. 7, illustration to the right and left of the shaft mount 88). On the other hand, in the illustrated embodiment the shaping shafts 84, 86 are tilted by the center axes 92, 93 thereof with respect to the center axis 89 of the shaft mount 88 similarly in correspondence with a pitch of the coiled tubing RW to be produced (see, in particular, FIGS. 11 and 12).

As a result, the shaping shafts 84, 86 form by the shape-imparting radial grooves 90 thereof a substantially helical path for the tubular extrudate EX capable of being shaped plastically. In that case, the axial spacings and tilt angles of the shaping shafts 84, 86 relative to the shaft mount 88 or the center axis 89 thereof are so selected that a section of the extrudate EX conveyed along the helical path is conveyed or runs on a circulatory path about the center axis 89 of the shaft mount 88 in those radial grooves 90, which are first as seen from the shaft mount 88, of the shaping shafts 84, 86 before this section of the extrudate EX for the second circulation about the center axis 89 of the shaft mount 88 is transferred without a step or kink to those radial grooves 90, which are second as seen from the shaft mount 88, of the shaping shafts 84, 86. This section is then further conveyed thereat until for the next circulation it is transferred to those radial grooves 90, which are next as seen from the shaft mount 88, of the shaping shafts 84, 86, etc.; only after passing the last—here fifth—radial grooves 90 of the shaping shafts 84, 86 does the extrudate EX, which solidifies to form the coiler tubing RW, leave the helical path formed by the shaping shafts 84, 86, as shown on the right in FIG. 7.

Moreover, in the illustrated embodiment the shaping shafts 86 of the outer ring 87 are each of multi-part construction, as can be seen in FIG. 8, with a shaft stub 94, which is rotatably mounted in the shaft mount 88, and a shaft segment 95, which is detachably mountable on the stub and which has the shape-imparting radial grooves 90 of the shaping shaft 86. In that case each shaping shaft 86, which is of multi-part construction, of the outer ring 87 has a magnetic coupling 96 which serves the purpose of detachably mounting the respective shaft segment 95 on the associated shaft stub 94.

In addition, the shaft segment 95 and the shaft stub 94 of each shaping shaft 86, which is of multi-part construction, of the outer ring 87 are provided with structures 97 which are of complementary form and which can be brought into interlocking mutual engagement for transmission of torque. In the illustrated embodiment the complementary formed structures 97 at shaft stub and shaft segment 94, 95 are formed by two pins 98 at one part (here the shaft segment 95) and radially outwardly open recesses 99 or axial grooves at the other part (here the shaft stub 94), which interengage in the mounted state of the respective shaping shaft 86, which is multi-part construction, of the outer ring 87.

As far as the rotatable mounting, which is not otherwise illustrated in the drawings, of the one-part shaping shafts 84 of the inner ring 85 in the shaft mount 88 are concerned, this is configured in analogous manner to the mounting of the shaft stubs 94 of the shaping shafts 86 of the outer ring 87. Accordingly, the shaping shafts 84 of the inner ring 85 extend in fixed orientation away from the shaft mount 88.

Provided in the illustrated embodiment for rotary drive of the shaping shafts 84 of the inner ring 85 and the shaping shafts 86 of the outer ring 87 is a common drive device 100 which shall be described in more detail in the following with reference to FIGS. 7 to 10. As considered in general, the drive device 100 according to FIGS. 1 to 3 comprises a radial transfer transmission 102, an electric motor 104 for drive of the radial transfer transmission 102 and an arrangement of proprietary telescopic universal-joint shafts 106 which produce the drive connection with the shaping shafts 84, 86 mounted on or in the shaft mount 88. Of these, the radial transfer transmission 102 is erected on a frame 103 and thus directly carries the other components and subassemblies of the shaping device 18 and the associated drive device 100, as will be evident from the following description.

The radial transfer transmission 102 as core element of the drive device 100 has, according to FIGS. 7 and 8, first and foremost an inlet-side housing half 107 and an outlet-side housing half 108, which together bound an interior space 109 for reception of the gearwheels 111, 113 of two transmission stages 110, 112 of the radial transfer transmission 102, namely a first transmission stage 110 for drive of the shaping shafts 84 of the inner ring 85 (gearwheels 111) and a second transmission stage 112 for drive of the shaping shafts 86 of the outer ring 87 (gearwheels 113). The electric motor 104 of the drive device 100 is flange-mounted on the inlet-side housing half 107 of the radial transfer transmission 102 by way of an adapter bell 114. In addition, according to FIG. 8 an input shaft 116, which is in drive connection with the electric motor 104, more precisely a drive output shaft (not shown) of the electric motor 104, of the radial transfer transmission 102 is rotatably mounted at a central point of the inlet-side housing half 107.

FIG. 8 also shows that the shaft mount 88 is secured at a central point of the outlet-side housing half 108 of the radial transfer transmission 102 with the help of a connecting rod 118 and associated fasteners 119 (threaded connection with the outlet-side housing half 108/rod step with washer and screw at the shaft mount 88). Output shafts 120, 121 corresponding with the number of shaping shafts 84, 86 of the shaping device 18, thus in total twelve in the illustrated embodiment, are rotatably mounted about the connecting rod 118 in the outlet-side housing half 108. The output shafts 120, 121 are in turn each in drive connection with a respective shaping shaft 84, 86 of the shaping device 18 by way of a respective one of the telescopic universal-joint shafts 106, as illustrated in FIG. 8 on the right at the top and bottom.

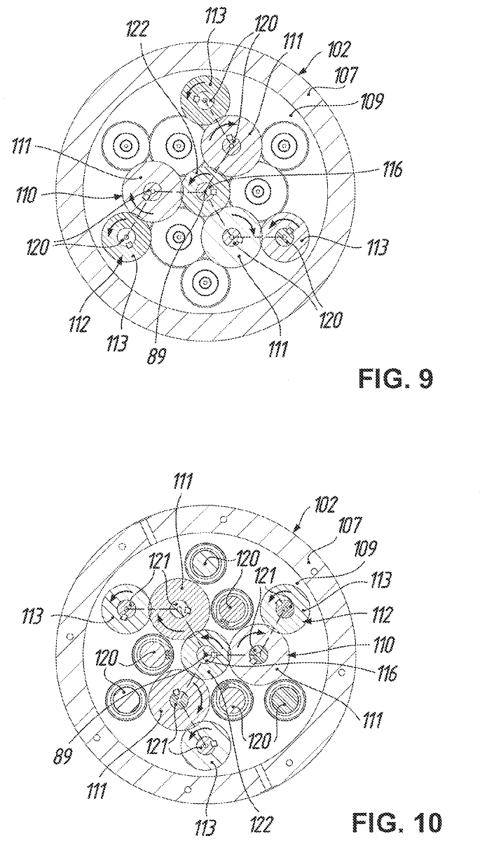

Moreover, it can be inferred from FIG. 8 that there are longer output shafts 120 and shorter output shafts 121, of which the longer output shafts 120 reach up to a first transmission plane corresponding with the section line IX-IX in FIG. 8, whereas the shorter output shafts 121 extend merely to a second transmission plane corresponding with the section line X-X in FIG. 8. The respectively associated gearwheels 111, 113 of the first transmission stage 110 and the second transmission stage 112 are secured to the output shafts 120, 121 in the interior space of the radial transfer transmission 102 by way of mechanically positive shaft/hub connections with keys, as shown in FIGS. 9 and 10.

According to FIGS. 8 to 10 a central pinion 122 is secured to the end, which projects into the interior space 109 of the radial transfer transmission 102, of the input shaft 116 and, in particular, similarly by way of a mechanically positive shaft/hub connection with a key. In that case, the pinion 122 extends in the interior space 109 axially over the two transmission planes. According to FIGS. 9 and 10, the pinion 122 meshes in the two transmission planes with in each instance three larger gearwheels 111, which with respect to the center axis 89 are distributed uniformly over the circumference, of the first transmission stage 110 for drive of the shaping shafts 84 of the inner ring 85, wherein the three larger gearwheels 111 of the first transmission plane are arranged to be angularly offset with respect to the three larger gearwheels 111 of the second transmission plane about the center axis 89 by 30°. Each of the larger gearwheels 111 of the first transmission stage 110 in turn meshes in the respective transmission plane with a respective smaller gearwheel 113 of the second transmission stage 112 for drive of the shaping shafts 86 of the outer ring 87. In addition, the three smaller gearwheels 113 of each transmission plane are distributed in the respective transmission plane uniformly over the circumference with respect to the center axis 89 and, in particular, again angularly offset from transmission plane to transmission plane about the center axis 89 by 30°.

The torque distribution from the central input shaft 116 to the different output shafts 120, 121 of the radial transfer transmission 102 is indicated in FIGS. 9 and 10 by dashed lines; arrows additionally mark the rotational directions of the different pinions 122 and gearwheels 111, 113 in FIGS. 9 and 10. It will be apparent to the person skilled in the art that as a consequence of the different sizes of the gearwheels 111, 113 the translation ratios of the two transmission stages 110, 112 of the radial transfer transmission 102 are different, whereby the shaping shafts 84 of the inner ring 85 rotate more slowly than the transmission shafts 86 of the outer ring 87. In other words, the translation ratios of the two transmission stages 110, 112 are selected in such a way that different circumferential speeds arise at the shaping shafts 84 of the inner ring 85 and the shaping shafts 86 of the outer ring 87 so as to convey the extrudate EX in substantially distortion-free manner through the shaping device 18. This is given when as seen in a cross-section of the extrudate EX each point of the extrudate EX moves at substantially the same angular speed about the center axis 89, wherein obviously radially inwardly disposed points of the extrudate EX cover a smaller path than radially outwardly disposed points of the extrudate EX. The translation ratios of the two transmission stages 110, 112 of the radial transfer transmission 102 take into account the fact that the circumferential speed radially outwardly at the extrudate EX is greater than the circumferential speed radially inwardly at the extrudate EX.

As already explained further above with reference to FIGS. 1 to 3, the cooling device 20 is provided in the region of the shaping device 18 of the device 10. In the illustrated embodiment the cooling device 20 comprises a water reservoir 124 mounted on the frame 103. Water can be conveyed from the water reservoir 124 by a pump (not shown) and passed onward via a nozzle holder 126 to a plurality of nozzles 128 shown in FIG. 1 and mounted on the nozzle holder 126.

The—in the illustrated embodiment, five—nozzles 128 of the cooling device 20 are, according to FIG. 1, substantially radially oriented with respect to the center axis 89 and in that case fan out to cover an angular range of approximately 120° about the center axis 89. With regard to the axial position of the nozzles 128, according to FIGS. 2 and 3 these are seated in the immediate vicinity of the shaft mount 88 so that they are already capable of delivering water in the region of the radial grooves 90, which are first as seen from the shaft mount 88, of the shaping shafts 84, 86 to the extrudate EX.

Finally, further details of the coiled tubing take-off 22 already mentioned in the introduction can be inferred from FIGS. 1 to 3. Accordingly, the coiled tubing take-off 22 comprises a rotary drive 130 by which the take-off rollers 24 can be rotationally driven in the same direction counter to the rotational direction of the coiled tubing RW delivered by the shaping device 18. For that purpose, in the illustrated embodiment the rotary drive 130 has an electric motor 134 which is mounted on a frame part 132 and which is in driving connection with the take-off rollers 24 by way of a belt drive 136, which comprises belt pulleys at the motor output and at the ends of the take-off rollers 24 as well as a cogged belt extending therebetween. Through suitable setting of the rotational speed of the electric motor 134 of the rotary drive 130 the take-off rollers 24 of the coiled tubing take-off 22 can be driven at a respective circumferential speed which corresponds with the circumferential speed at the outer circumference of the coiled tubing RW conveyed from the shaping device 18 or which is even slightly greater than the latter, so that the coiled tubing RW on leaving the helical path between the shaping shafts 84, 86 experiences a certain degree of tension when coming into contact with the take-off rollers 24 perpendicularly to the profile cross-section PQ.

It will be apparent to the skilled person that with the afore-described device 10 it is possible to perform a method for producing coiled tubing RW from a thermoplastic plastics material in which two shaping steps directly follow one another. In that case, it is generally stated (1st) in a first shaping step the tubular extrudate EX is extruded by way of the annular nozzle gap 16 of the extruder 12, whereupon (2nd) in a second shaping step directly subsequent to the first shaping step the extrudate EX drawn down from the nozzle gap 16 and capable of being shaped plastically is calibrated or sized in the shaping device 18 in order to achieve the geometrically defined profile cross-section PQ as well as shaped to form the coiled tubing RW before the coiled tubing RW with the geometrically defined profile cross-section PQ solidifies. The latter has, as far as stability of size and shape are concerned, very small size and shape tolerances by comparison with the prior art outlined in the introduction (see with respect thereto also FIGS. 14 and 15 by comparison). In the illustrated embodiment the extrudate EX capable of being shaped plastically is, for the second shaping step in the shaping device 18 of the device 10, drawn down directly from the nozzle gap 16 of the extruder 12 by the shaping device 18 specifically driven for that purpose.

Moreover, through the special design of the injection head 14 of the device 10 with the supporting air bore 78 connected with the compressed air source 82 the calibrating or sizing of the extrudate EX, which is capable of being shaped plastically, in the shaping device 18 is carried out with the feed of supporting air through a cavity HR (see FIGS. 11 and 12) of the extrudate EX.

During the second shaping step for forming the coiled tubing RW with the geometrically defined and calibrated or sized profile cross-section PQ it is, moreover, possible to actively cool the extrudate EX in the shaping device 18. In the illustrated embodiment a liquid coolant, namely water, which is delivered by the cooling device 20 to the extrudate EX conveyed through the shaping device 18, is used for active cooling of the extrudate EX in the shaping device 18. In that case, the water sucked from the water reservoir 124 passes via the nozzles 128, which are secured in alignment to the nozzle holder 126, directly to the extrudate EX conveyed through the shaping shafts 84, 86. Since the shaping device 18 is placed above the water reservoir 124 of the cooling device 20, the water delivered to the extrudate EX drips or flows in a circuit back to the water reservoir 124. Additional measures can be provided in or at the water reservoir 124 (not shown in the figures) so as to provide temperature control of the circulating water, for example a compressor cooling device.

The afore-described multi-part construction of the shaping shafts 86 of the outer ring 87 facilitates, above all, start-up of production of the coiled tubing RW. During start-up initially the shaft segments 95 of the outer shaping shafts 86 are not yet placed on the associated shaft stubs 94. The tubular extrudate EX which is issuing from the nozzle gap 16 of the extruder 12 and which is capable of being shaped plastically is consequently laid directly around the shaping shafts 84, which are each rotating around the individual center axis 92, of the inner ring 85 of the annular shape. In that case, the extrudate EX also follows the pitch resulting from the afore-described arrangement or orientation of the shape-imparting radial grooves 90 of the shaping shafts 84, i.e. it forms a spiral or helix. An embracing, which follows the annular shape, of the shaping shafts 84 of the inner rings 85 arises through the now switched-on water cooling by the cooling device 20, wherein the shaping device 18 conveys the extrudate EX onward. The shaft segments 95 are now in turn placed on the associated shaft stubs 94 of the shaping shafts 86 of the outer ring 87 and in a given case the pressure of the supporting air, which is generated by the compressed air source 82 and which is delivered by way of the supporting air bores 78 to the cavity HR of the extrudate EX, is increased until the extrudate EX has complete contact with the shaping shafts 84 of the inner ring 85 as well as the shaping shafts 86 of the outer ring 87 and consequently forms a round profile cross-section PQ in correspondence with the geometry of the radial grooves 90 and without ovality. In other words, here the extrudate EX capable of being shaped plastically is calibrated in the second shaping step in order to achieve the substantially circularly annular profile cross-section PQ according to the illustrated embodiment and is at the same time brought into the helical shape.

A further advantage of the divided shaping shafts 86 of the outer ring 87 is the thereby-achieved operating reliability. Since the shaping shafts 84 of the inner ring 85 and the shaping shafts 86 of the outer ring 87 rotate in opposite directions in correspondence with the arrows in FIGS. 11 and 12 there is basically a risk that, for example, fingers of the operator are drawn into the intermediate space between the shaping shafts 84, 86. If this happens, as a consequence of the divided construction of the shaping shafts 86 the fitted shaft segment 94 can simply deflect with respect to the associated shaft stub 94. This effect is also very helpful during production, since in the case of possible thickenings in the extrudate EX the shaft segments 95 can deflect before—as a consequence of the provided magnetic couplings 96—they automatically return to their starting position, so that the shaping device 18 is not blocked or even damaged.

After leaving the shaping device 18 the solidified coiled tubing RW is cut to defined length in a first making-up step. This can be carried out manually or automatically.

Thus, a separating or cutting device (not shown) can be provided in the region of the coiled tubing take-off 22 or therebehind as seen in the direction of the material flow depending on the desired length of the coiled tubing RW initially produced to be endless. The coiled tubing RW is initially suitably drawn apart or spread open in this device so that a separating or cutting tool in the form of nippers, shears, a guillotine knife with support and counter-cutter, or the like, can be placed against a coil of the coiled tubing RW so as to sever or cut the coiled tubing RW at a right angle to the tube course.

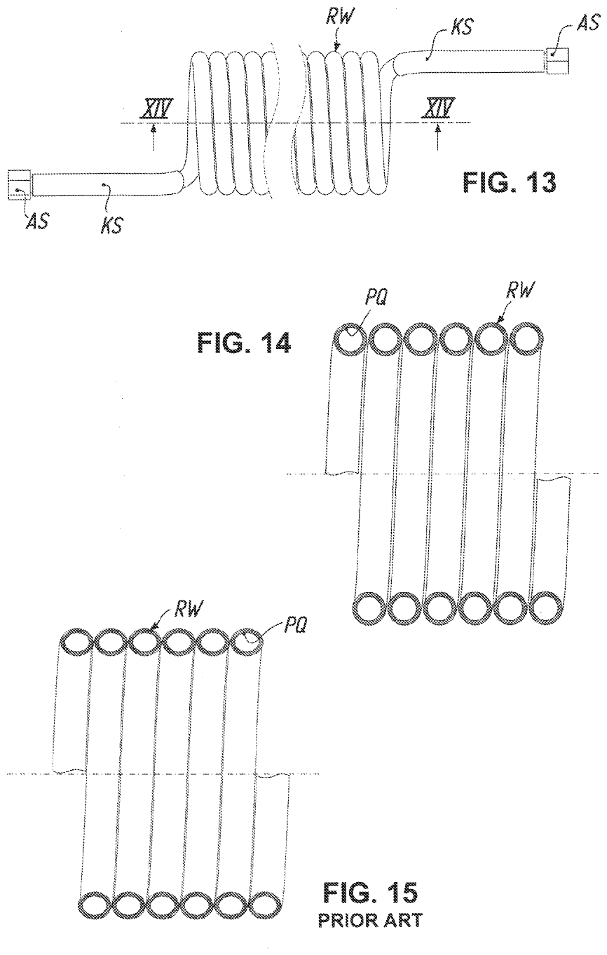

The coiled tubing RW cut to length in defined manner is thereafter provided in a second making-up step at one or both ends with a kink protection KS and/or a connecting member AS (cf. FIG. 13). For that purpose, it can initially be necessary depending on the kind of finish of the coiled tubing RW—coiled tubing with coiled tubing ends running out in circumferential direction, coiled tubing with coiled tubing ends running out in axial direction of the helix, or coiled tubing with combined coiled tubing ends—to locally heat the coiled tubing RW and plastically deform it again so as to angle over one or both connecting ends for an axially extending departure, as shown in FIG. 13.

If required or necessary, the kink protection KS is then pushed onto the respective end of the coiled tubing RW. This is usually a metallic helical spring or a tubular or elbow-shaped plastics material part with color coding, which tapers towards an end at the inner circumference so that it can be fixed on the coiled tubing RW. Finally, the usually metallic connecting member AS is pressed or knocked into the respective end of the coiled tubing RW at room temperature so as to complete the coiled tubing RW in correspondence with FIG. 13.

In addition, there are one-part or pre-mounted, combined kink-protection/connecting members (not shown) which can be mounted at the respective end of the coiled tubing in one work step. Finally, the afore-described making-up steps can be carried out together with their respective sub-steps—spreading-apart or spreading-open the coiled tubing RW/separating or cutting the coiled tubing RW/optional angling-over of the respective coiled tubing end/optional attachment of the kink protection KS to the respective coiled tubing end/attachment of the connecting member AS or a combined kink-protection/connecting member to the respective coiled tubing end—in fully automated or partly automated manner on, for example, a rotary worktable (not illustrated).

In a method for producing coiled tubing from a thermoplastic plastics material, in a first shaping step a tubular extrudate is extruded by way of an annular nozzle gap of an extruder before the extrudate which is drawn down from a nozzle gap and capable of being shaped plastically is, in a second shaping step directly subsequent to the first shaping step, calibrated or sized in a shaping device in order to achieve a geometrically defined profile cross-section as well as shaped to form the coiled tubing, whereupon the coiled tubing with the geometrically defined profile cross-section solidifies. This method enables endless production of the coiled tubing with a new, high level of quality with respect to size and shape tolerances of the profile cross-section of the coiled tubing. In addition, a device for producing such coiled tubing is proposed.

### REFERENCE NUMERAL LIST

10 device
12 extruder
14 injection head
16 nozzle gap
18 shaping device
20 cooling device
22 coiled tubing take-off
24 take-off roller
26 base frame
28 worm cylinder
30 extruder worm
32 thrust bearing bell
34 geared motor
36 filling opening
38 heating/cooling combination
40 cable channel
42 base body
44 threaded bore
46 flange member
48 heating band
50 centering ring
52 injection head inlet
54 spacer ring
56 stepped bore
58 nozzle holder
60 interior space
62 webbed mandrel holder
64 outer nozzle
66 inner nozzle
68 centering screw
70 passage
72 blind bore
74 transverse bore
76 connecting bore
78 supporting air bore
80 end surface
82 compressed air source
84 shaping shaft
85 inner ring
86 shaping shaft
87 outer ring
88 shaft mount
89 center axis
90 radial groove
91 groove cross-section
92 center axis
93 center axis
94 shaft stub
95 shaft segment
96 magnetic coupling
97 structures of complementary configuration
98 pin
99 recess
100 drive device
102 radial transfer transmission
103 frame
104 electric motor
106 telescopic universal-joint shaft
107 inlet-side housing half
108 outlet-side housing half
109 interior space
110 first transmission stage
111 gearwheel of the first transmission stage
112 second transmission stage
113 gearwheel of the second transmission stage
114 adapter bell
116 input shaft
118 connecting rod
119 fasteners
120 output shaft
121 output shaft
122 pinion
124 water reservoir
126 nozzle holder
128 nozzle
130 rotary drive
132 frame part
134 electric motor
136 belt drive
AS connecting member
EX extrudate
HR cavity
KS kink protection
PQ profile cross-section
RW coiled tubing

What is claimed is:

1. A method of producing a coiled tubing (RW) from a thermoplastic plastics material, in which
in a first shaping step a tubular extrudate (EX) is extruded by way of an annular nozzle gap (16) of an extruder (12) and
the extrudate (EX), which is drawn down from the nozzle gap (16) and capable of being shaped plastically, is calibrated or sized and formed into the coiled tubing (RW) in a second shaping step directly subsequent to the first shaping step in a shaping device (18) to achieve a geometrically defined profile cross-section (PQ),
before the coiled tubing (RW) with the geometrically defined profile cross-section (PQ) solidifies.

2. A method of producing a coiled tubing (RW) according to claim 1, wherein the extrudate (EX) capable of being shaped plastically is for the second shaping step drawn down from the nozzle gap (16) by the shaping device (18).

3. A method of producing a coiled tubing (RW) according to claim 1, wherein the calibrating or sizing of the extrudate (EX) capable of being shaped plastically is carried out in the shaping device (18) with the feed of supporting air via a cavity (HR) of the extrudate (EX).

4. A method of producing a coiled tubing (RW) according to claim 1, wherein the extrudate (EX) is actively cooled during the second shaping step in the shaping device (18).

5. A method of producing a coiled tubing (RW) according to claim 4, wherein a liquid coolant is used for active cooling of the extrudate (EX) in the shaping device (18).

6. A method of producing a coiled tubing (RW) according to claim 1, wherein the extrudate (EX) capable of being shaped plastically is calibrated or sized in the second shaping step so as to achieve a substantially circularly annular profile cross-section (PQ).

7. A method of producing a coiled tubing (RW) according to claim 1, wherein the solidified coiled tubing (RW) after leaving the shaping device (18) is cut to length in defined manner in a first making-up step.

8. A method of producing a coiled tubing (RW) according to claim 7, wherein the coiled tubing (RW) cut to defined length is provided in a second making-up step with a kink protection (KS) and/or a connecting member (AS) at one end or both ends.

9. A device (10) for producing a coiled tubing (RW) from a thermoplastic plastics material, by the method according to claim 1, comprising:
an extruder (12) with an injection head (14) having an annular nozzle gap (16) by way of which a tubular extrudate (EX) can be delivered in a state capable of being shaped plastically, and
a shaping device (18) for further shaping of the tubular extrudate (EX), which is capable of being shaped plastically, to form the coiled tubing (RW) with a profile cross-section (PQ) of geometrically defined size,
wherein the shaping device (18) is driven and so arranged with respect to the injection head (14) of the extruder (12) that it is capable of drawing down the tubular extrudate (EX), in the state capable of being shaped plastically, directly from the annular nozzle gap (16).

10. A device (10) for producing a coiled tubing (RW) according to claim 9, wherein the shaping device (18) comprises a plurality of rotationally drivable shaping shafts (84, 86) which are so arranged at a shaft mount (88) secure against rotation that they form an inner ring (85) of shaping shafts (84) and an outer ring (87) of shaping shafts (86), and wherein the shaping shafts (84) of the inner ring (85) are drivable in opposite direction to the shaping shafts (86) of the outer ring (87) so as to convey the tubular extrudate (EX), which is capable of being shaped plastically, between the inner ring (85) and the outer ring (87).

11. A device (10) for producing a coiled tubing (RW) according to claim 10, wherein each shaping shaft (84, 86) has a plurality of shape-imparting radial grooves (90) with a geometrically defined groove cross-section (91), the grooves being arranged in succession at a slight spacing from one another as seen along a center axis (92, 93) of the shaping shaft (84, 86).

12. A device (10) for producing a coiled tubing (RW) according to claim 11, wherein the shape-imparting radial grooves (90) of the shaping shafts (84, 86) have a substantially semicircular groove cross-section (91).

13. A device (10) for producing a coiled tubing (RW) according to claim 10, wherein the shaping shafts (84, 86) project to different extent from the shaft mount (88) in correspondence with the pitch of the coiled tubing (RW) to be produced and/or are tilted by the center axes (92, 93) thereof with respect to a center axis (89) of the shaft mount (88) so as to form by their shape-imparting radial grooves (90) a substantially helical path for the tubular extrudate (EX) which is capable of being shaped plastically.

14. A device (10) for producing a coiled tubing (RW) according to claim 10, wherein at least one shaping shaft (86) of the outer ring (87) is of multi-part construction with a shaft stub (94), which is rotatably mounted in the shaft mount (88), and a shaft segment (95), which can be detachably mounted on the shaft stub and which has shape-imparting radial grooves (90) of the shaping shaft (86).

15. A device (10) for producing a coiled tubing (RW) according to claim 14, wherein the shaping shaft (86), which is of multi-part construction, of the outer ring (87) has a magnetic coupling (96) serving the purpose of detachably retaining the shaft segment (95) at the shaft stub (94).

16. A device (10) for producing a coiled tubing (RW) according to claim 14, wherein the shaft segment (95) and the shaft stub (94) of the shaping shaft (96), which is of multi-part construction, of the outer ring (87) are provided with structures (97) which are of complementary configuration and which can be brought into interlocking mutual engagement for transmission of torque.

17. A device (10) for producing a coiled tubing (RW) according to claim 16, wherein the complementary structures at the shaft segment (95) and shaft stub (94) are formed by pins (98) at one part and outwardly open recesses (99) at the other part, which pins and recesses interengage in the mounted state of the shaping shaft (86), which is of multi-part construction, of the outer ring (87).

18. A device (10) for producing a coiled tubing (RW) according to claim 10, wherein the shaping shafts (86) of the outer ring (87) and the shaping shafts (84) of the inner ring (85) are drivable by a common drive device (100).

19. A device (10) for producing a coiled tubing (RW) according to claim 18, wherein the drive device (100) has a motor (104) which is in driving connection with an input shaft (116) of a radial transfer transmission (102), which in correspondence with the number of shaping shafts (84, 86) of the shaping device (18) has output shafts (120, 121) which in turn are each in driving connection with a respective shaping shaft (84, 86) of the shaping device (18).

20. A device (10) for producing a coiled tubing (RW) according to claim 19, wherein the output shafts (120, 121) of the radial transfer transmission (102) are in driving connection with the shaping shafts (84, 86) of the shaping device (18) by way of telescopic universal-joint shafts (106).

21. A device (10) for producing a coiled tubing (RW) according to claim 19, wherein the radial transfer transmission (102) of the drive device (100) comprises two transmission stages (110, 112), namely a transmission stage (110) for drive of the shaping shafts (84) of the inner ring (85) and a transmission stage (112) for drive of the shaping shafts (86) of the outer ring (87), and wherein the translation ratios of the transmission stages (110, 112) are selected in such a way that different circumferential speeds arise at the shaping shafts (84) of the inner ring (85) and the shaping shafts (86) of the outer ring (87) so as to convey the extrudate (EX) through the shaping device (18) substantially free of distortion.

22. A device (10) for producing a coiled tubing (RW) according to claim 9, wherein a coiled tubing take-off (22) is provided downstream of the shaping device (18) in the material flow, comprising two take-off rollers (24), which extend substantially parallel to one another and which are adapted for the purpose of rotationally supporting the coiled tubing (RW) after leaving the shaping device (18).

23. A device (10) for producing a coiled tubing (RW) according to claim 22, wherein the coiled tubing take-off (22) comprises a rotary drive (130) by which the take-off rollers (24) are rotationally drivable in the same direction counter to the rotational direction of the coiled tubing (RW) delivered by the shaping device (18).

24. A device (10) for producing a coiled tubing (RW) according to claim 9, wherein a cooling device (20) for delivery of a cooling fluid, by which the extrudate (EX) conveyed by the shaping device (18) can be actively cooled, is provided in the region of the shaping device (18).

25. A device (10) for producing a coiled tubing (RW) according to claim 9, wherein the injection head (14) of the extruder (12) has a supporting air bore (78) which opens at an end surface (80) of the injection head (14) radially within the annular nozzle gap (16).
